(19) United States
(12) Patent Application Publication
(10) Pub. No.: US 2004/0242725 A1
(43) Pub. Date: Dec. 2, 2004

(54) Ionically cross-linked paste inks

(76) Inventors: Gordon Kotora, Clifton, NJ (US); Edward Stone, Morris Plains, NJ (US); Neil Young, Oakland, NJ (US)

Correspondence Address: SUN CHEMICAL COPORATION, 222 BRIDGE PLAZA SOUTH, FORT LEE, NJ, 07024, US

(21) Appl. No.: 09/982,494

(22) Filed: Oct. 18, 2001

(51) Int. Cl. C03C 17/00; C09D 5/00

(52) U.S. Cl. 523/160; 523/161

(57) ABSTRACT

A coating or a paste ink formulation is provided which contains tonically cross-linked polymers, wherein said ionic cross-linking is between functional acid and amino groups. In addition, a method of preparing a coating or a paste ink composition is also provided which includes: (a) providing polymers containing functional acid and/or amino groups; and(b) ionically cross-linking at least a portion of the acid groups with the amino groups.

### FIELD OF THE INVENTION

This invention relates to coatings or paste ink formulations containing ionically cross-linked polymers that help in controlling Theological characteristics and enhance various other properties of the coating or paste ink.

### BACKGROUND OF THE INVENTION

Conventional paste inks currently use a variety of different varnishes to impart the structural properties necessary to give proper lithographic performance and control factors such as misting. These varnishes are usually resins that are gelled with inorganic gellants such as oxy aluminum octoate(OAO) or ethylacetoacetate chelated aluminum di-isopropoxide (AIEM). The manufacture of these gelled varnishes is usually poorly controlled and adds expense to the finished product.

The use of self-structured resins is another way to control rheology without the need for gelling agents, but this method is also limited by manufacturing difficulties in making highly structured resins. The present invention provides a novel and most effective method for controlling the rheology and properties of a coating or ink.

### SUMMARY OF THE INVENTION

The present invention relates to a coating or a paste ink formulation comprising ionically cross-linked polymers, wherein said ionic cross-linking is between functional acid and amino groups.

The present invention also provides a method of preparing a coating or a paste ink composition comprising: (a) providing polymers containing functional acid and/or amino groups; and(b) ionically cross-linking at least a portion of the acid groups with the amino groups.

### BRIEF DESCRIPTION OF THE DRAWINGS

FIG. 1 illustrates rheology curves of a 1/1 mixture of Acidic Varnish #1 and Amino Varnish #2 (see Example 1 for composition) with varying percentage of the carboxylic acid groups blocked by ethyl morpholine.

FIG. 2 illustrates rheology curves of a blocked 1/1 mixture of Acidic Varnish #1 and Amino Varnish #2 (33% of carboxylic acid groups blocked), prepared fresh and aged for one month. The results indicate that there is very little build-up in structure over that period.

### DETAILED DESCRIPTION OF THE INVENTION

It has now surprisingly been found that rheology and printing properties of coatings or paste inks as indicated herein below can be significantly improved by ionically cross-linking functional acid groups on one polymer with functional amino groups on another polymer. The coating or paste ink may further contain UV or EB radiation curable acrylic diluents and optionally reactive oligomers. Preferably, the acid groups are carboxylic acid groups. Also, preferably, the amino groups are di- or tri-substituted. However, in the case of UV or EB radiation curing, tri-substituted amines are preferred because mono-amines and di-amines may undergo the Michael addition of the NH group on to the acrylic double bond. The net result is the formation of a polymer cross-linked through ionic bonds, i.e., a polymeric salt.

The polymers used in the present invention can be selected from a wide variety such as acrylic, polyester, polyesteramide, polyurethane, polyamide or rosin-based polymers. Rosin-based acidic polymers are preferable for cost effectiveness reasons and because they provide the opportunity to obtain performance properties equal to heatset inks. Preferably, the polymer containing the amino groups has an amine value (mg.KOH/gram of polymer) of at least 10, more preferably at least 30 and most preferably at least 50. Also preferably, the polymer containing the acid groups has an acid value (mg.KOH/gram of polymer) of at least 10, more preferably at least 30 and most preferably at least 50.

Changing the acid to base (A/B) ratio controls the degree of cross-linking. The degree of cross-linking can also be controlled by partially or completely neutralizing the acid groups with a volatile amine such as ammonia and mono-, di- or tri-substituted amines. The volatility of the amine and the solvent determines the rate of cure or cross-linking and thus the dry speed. The ultimate properties of the cured film depend to a large extent on the nature and structure of the polymer backbone as well as the crosslink density. Similarly, it would be obvious to those skilled in the art that the amino groups of the polymer may be blocked with a volatile acid like formic, acetic or lactic acid to control rheology. This method although feasible would be less desirable in a pressroom.

In the special case of UV or EB radiation curing, the use of a volatile amine blocking agent to control the viscosity of the ink/coating offers the advantages of a dual cure mechanism.

One of the advantages of this invention over prior art is that the polymers can be of relatively low molecular weight and therefore easier to manufacture. Another advantage of the low molecular weight is that the polymers are more soluble in heatset solvents. This would allow formulation of high solids inks. Another advantage of this invention is that rheology can be controlled by simply adjusting the A/B ratio. Thus, misting and other press related problems may be more readily controlled. Still another advantage is that the resistance properties of the cured ink or coating can be improved by properly selecting the polymers and the degree of cross-linking. This is particularly important in the case of magazine covers that are marred or damaged by surface to surface rubbing (friction) of the ink film while in transit.

Using this concept of manipulating the rheological characteristics of the coating or ink through acid/base ratio and employing blocking agents, inks may be made for waterless and conventional lithography, news inks, radiation curable inks, screen inks and other solvent based inks.

### EXAMPLE 1

The following table shows the composition of two amino acrylic varnishes suitable for use in the present invention.

| | Amino acrylic | Amino acrylic |
|---|---|---|
| Ingredients | Varnish #1 | Varnish #2 |
| Polymer composition | | |
| % DMAEMA* polymer | 14.0 | 14.0 |
| % Lauryl Methacrylate | 24.0 | 18.0 |
| % Paramethylstyrene | 62.0 | 68.0 |
| % Magie 470 | 34.7 | 34.7 |
| % TDA | 0.0 | 0.0 |
| Calculated | 50 | 50 |
| Amine Value | | |

*DMAEMA = Dimethyl amino ethyl methacrylate.

The composition of two representative acidic acrylic varnishes is given below.

| | Acidic | Acidic |
|---|---|---|
| | acrylic | acrylic |
| Ingredients | Varnish #1 | Varnish #2 |
| Polymer composition | | |
| % Methacrylate Acid | 8.0 | 8.2 |
| % Lauryl Methacrylate | 19.2 | 25.6 |
| % Paramethylstyrene | 72.6 | 66.2 |
| % Magie 470 | 29.6 | 25.1 |
| % TDA | 9.0 | 22.9 |
| Calculated Acid Value | 53.6 | 53.6 |

The combination of amino and acid acrylic varnishes gave an immediate increase in viscosity and elasticity as the reaction to form the salt structure was almost instantaneous.

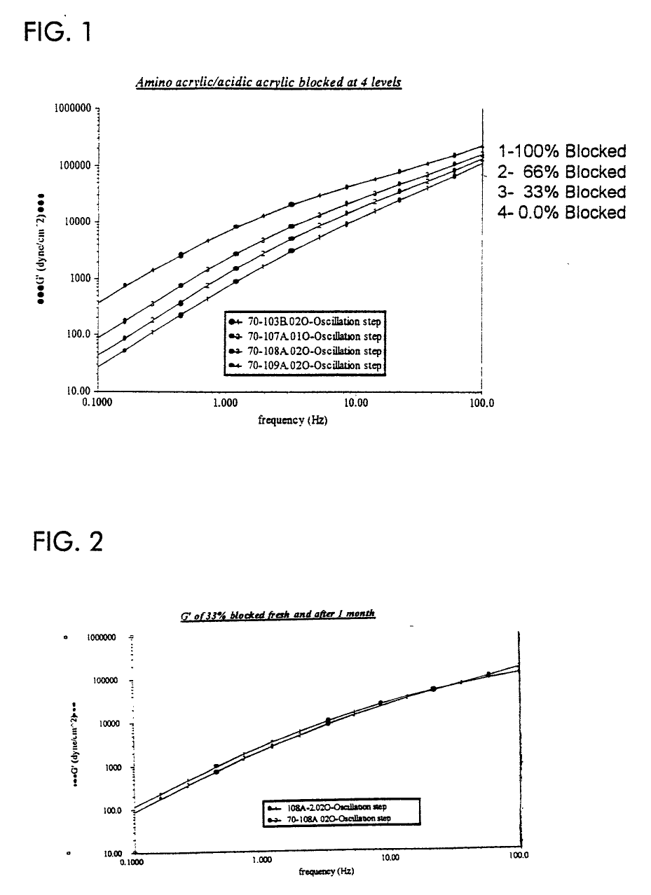

This reaction could be controlled however, by partially neutralizing the COOH groups with a volatile tri-substituted amine such as ethyl morpholine (a blocking agent). After mixing 1 part of Acidic Varnish #1 with a part of Amino Varnish #2 and also by varying the amount of blocking agent added (degree of neutralization), a wide range of gel-like structures having progressively different rheological properties could be prepared as shown in FIG. 1.

This structure has also been remarkably stable over a period of months demonstrating that stable, controlled rheological structures are possible (see FIG. 2).

When the above 1/1 mixture of Acidic Varnish #1 and Amino Varnish #1 was dried in a Sinvatrol (at 40 fpm/400° F./1 pass), very clear, high gloss films were obtained. These films had excellent resistance to water, Magie 470, and isopropyl alcohol, demonstrating its usefulness as an overprint varnish.

### EXAMPLE 2

Rosin based acidic polymers with polyamides were the acidic and amino varnishes used in preparing an ink formulation. The acidic varnish (Acidic Rosin Varnish #1) used was simply a solution of Filtrez 690 in Magie 470 blocked with 1 eq of ethyl morpholine. The specific amine (polyamide) Varnish (Amine Varnish #1) used is detailed below.

| | Amine Rosin |
|---|---|
| Ingredients | Varnish #1 |
| Sylvadyme T-18* | 31.15% |
| Adipic Acid | 3.93% |
| MEHQ | 0.05% |
| Isophoronediamine | 18.76% |
| Magie 470 | 26.90% |
| TDA | 19.20% |

*Sylvadyme T-18 is a dimer acid obtained from Arizona Chemical Co.

These varnishes were combined at 1/1 ratio with standard heatset flushes to formulate magenta and cyan inks as shown in the formula below.

| Component | Magenta Ink | Cyan Ink |
|---|---|---|
| Magenta H/S Flush | 31.6% | 0.0% |
| Cyan H/S Flush | 0.0% | 31.6% |
| 1/1 combination of Acidic | 63.2% | 63.2% |
| rosin Varnish #1 and | | |
| Amine Rosin Varnish #1 | | |
| TDA | 5.2% | 5.2% |

These inks were printed and then cured according to conventional methods. The inks were then dried at 410° F., 40 fpm, 1 pass. Both the Magenta and Cyan inks had excellent gloss and printability, good color strength, and moderate to good resistance to Magie 470, isopropyl alcohol and water.

### EXAMPLE 3

A polyurethane acrylate was utilized as the amino varnish polymer and an epoxy acrylate as the acidic polymer to make energy curable inks. The polyurethane composition is as follows:

| Polyurethane | % |
|---|---|
| Isophorone diisocyanate | 33.3 |
| Propylene glycol - 400 | 30.1 |
| Dimethyl ethanolamine | 3.9 |
| Methyl diethanolamine | 1.0 |
| Triethanolamine | 1.7 |
| Propoxylated neopentylglycol | 30.0 |
| | (Henkel 4127) |
| diacrylate | 100.0 |

A bisphenol epoxy acrylate was first prepared by reacting Shell Chemical Epon 828 (70%) with 21% acrylic acid and 7% perlargonic acid. This material was further reacted with the anhydrides indicated below.

| | % |
|---|---|
| Bisphenol A epoxy acrylate | 71.7 |
| Propoxylated neopentylglycol diacrylate | 21.1 |
| Benzophenone tetracarboxylic dianhydride | 2.7 |
| Succinic anhydride | 4.5 |
| | 100.0 |

These materials were used to prepare energy curable inks. Varnish and ink formulations were prepared as indicated below.

| | % |
|---|---|
| Varnish Composition | |
| Epoxy acrylate (above) | 50.0 |
| Polyurethane acrylate (above) | 11.5 |
| Polyether acrylate (Satomer CN-551) | 21.0 |
| PO NPGDA | 17.5 |
| | 100.0 |
| Ink Formulation | |
| Varnish (above) | 38.0 |
| PO NPGDA | 10.0 |
| Pigment base | 50.0 |
| Talc | 2.0 |
| | 100.0 |

PO NPGDA = propoxylated neopentylglycol diacrylate (Henkel 4127)

This ink exhibited good cure response with electron beam curer, excellent gloss and very good alcohol rubs. Essentially, no misting was observed on the inkometer at 2000 rpm.

The invention has been described in terms of preferred embodiments thereof, but is more broadly applicable as will be understood by those skilled in the art. The scope of the invention is only limited by the following claims.

What is claimed is:

1. A coating or paste ink formulation comprising ionically cross-linked polymers, wherein said ionic cross-linking is between a polymer containing acid functional groups and a polymer containing amino functional groups.

2. The formulation of claim 1, wherein the polymer containing the amino groups has an amine value of about 10 to 300.

3. The formulation of claim 1, wherein the polymer containing the amino groups has an amine value of at about 25 to 100.

4. The formulation of claim 1, wherein at least some of the acid functional groups are carboxylic acid groups.

5. The formulation of claim 1, wherein the polymer containing the acid groups has an acid value of about 10 to

6. The formulation of claim 1, wherein the polymer containing the acid groups has an acid value of 25 to 100.

7. The formulation of claim 1, wherein the amino groups are di- or tri-substituted amines.

8. The formulation of claim 1, wherein said acid functional groups are partially or completely neutralized by a volatile amine.

9. The formulation of claim 8, wherein the volatile amine is mono-, di- or tri-substituted.

10. The formulation of claim 8, wherein the volatile amine is ammonia.

11. The formulation of claim 1, wherein at least one of the polymers is selected from the group consisting of an acrylic, polyester, polyesteramide, polyurethane, and polyamide polymer.

12. The formulation of claim 1, wherein at least one of the polymers is a rosin containing polymer.

13. The formulation of claim 1, wherein the ink or coating further contains UV or EB radiation curable acrylic diluents and optionally reactive oligomers.

14. A method of preparing a coating or a paste ink composition comprising:
(a) providing polymers containing functional acid and/or amino groups; and
(b) Tonically cross-linking at least a portion of the acid groups with the amino groups.

15. The method of claim 14, wherein the polymer containing the amino groups has an amine value of about 10 to 300.

16. The method of claim 14, wherein the polymer containing the amino groups has an amine value of about 25 to 100.

17. The method of claim 14, wherein the polymer containing the acid groups has an acid value of about 10 to

18. The method of claim 14, wherein the polymer containing the acid groups has an acid value of about 25 to 100.

19. The method of claim 14, wherein the amino groups are di- or tri-substituted amines.

20. The method of claim 14 further comprising neutralizing a portion of the acid groups by a volatile amine.

21. The method of claim 20, wherein the volatile amine is mono-, di- or tri-substituted.

22. The method claim 20, wherein the volatile amine is ammonia.

23. The method of claim 14, wherein at least one of the polymers is selected from the group consisting of an acrylic, polyester, polyesteramide, polyurethane, and polyamide polymer.

24. The method of claim 14, wherein at least one of the polymers is a rosin containing polymer.

25. The method of claim 14, wherein the ink or coating further contains UV or EB radiation curable acrylic diluents and optionally reactive oligomers.
